(19) United States
(12) Patent Application Publication
(10) Pub. No.: US 2026/0238367 A1
(43) Pub. Date: Aug. 13, 2026

(54) MULTIBAND RADIO SYSTEMS AND METHODS WITH DUAL TRIPLEXERS AND SINGLE FRONT-TO-BACK END COAXIAL CONNECTOR CABLE

(71) Applicant: GM GLOBAL TECHNOLOGY OPERATIONS LLC, Detroit, MI (US)

(72) Inventors: Uriel Z. Odes, Givaat Shmuel (IL); Yossi Diller, PetahTikva (IL)

(73) Assignee: GM GLOBAL TECHNOLOGY OPERATIONS LLC, Detroit, MI (US)

(21) Appl. No.: 19/049,236

(22) Filed: Feb. 10, 2025

(51) Int. Cl. H04H 40/45; H04B 1/00; H04B 1/10; H04L 27/06; H04L 27/10

(52) U.S. Cl. CPC H04H 40/45; H04B 1/0057; H04L 27/06; H04L 27/10; H04B 2001/1072; H04H 2201/183; H04H 2201/186

(57) ABSTRACT

Presented are AM/FM/DAB radio systems with dual RF/DC triplexers and a single front-to-back end coaxial connector cable, methods for making/using such radio systems, and vehicles equipped with such radio systems. An AM/FM/DAB radio system includes a tuner antenna module (TAM) containing a DAB front end module (FEM) and an AM/FM FEM, and a radio receiver module (RRM) containing a DAB receiver module (RXM) and an AM/FM RXM. A single coax cable connects the TAM and RRM and transmits therebetween RF signals and DC power. A triplexer unit is located inside the TAM and includes an FE coax node connected to the single coax cable, an AM/FM RF node connected to the AM/FM FEM to receive AM/FM RF signals, and a DAB RF node connected to the DAB FEM to receive DAB RF signals. The triplexer unit combines AM/FM/DAB RF signals for transmission across the single coax cable to the RRM.

### INTRODUCTION

The present disclosure relates generally to amplitude-modulation/frequency-modulation (AM/FM) radio systems. More specifically, aspects of this disclosure relate to multiband AM/FM/digital-audio-broadcasting (DAB) radio systems for motor vehicles.

Current production motor vehicles, such as the modern-day automobile, are originally equipped with a network of onboard controllers and wireless communications devices that enable a variety of vehicle services, such as navigation assistance, multimedia entertainment, and cellular connectivity. To provide occupants with telecommunications and informatics functionality, for example, many vehicle passenger compartments are now furnished with a center-stack telematics unit that operates as both a human-machine interface (HMI) and an in-vehicle computing device for vehicle occupants. The telematics unit may wirelessly connect to a cellular network and a satellite service for such purposes as real-time navigation, customer support, vehicle diagnostics, traffic data, and satellite radio services. In general, the telematics unit functions as a bidirectional radio transceiver that is able to simultaneously transmit and receive data in the form of network data packets. Data packets may be transmitted via ultra-high frequency (UHF), super-high frequency (SHF), and/or extremely-high frequency (EHF) radio signals from a cell tower to a cellular-enabled vehicle via downlink (or download) transmission and, conversely, may be transmitted via uplink (or upload) transmission from the vehicle to a cell tower. In addition to cellular communications, many telematics units also receive data over radio-frequency (RF) channels that provide analog “modulated” radio stations and digital “wide-band” radio stations.

### SUMMARY

Presented herein are multiband AM/FM/DAB radio systems with dual RF/DC triplexers and a single front-to-back end connector cable, methods for manufacturing and methods for operating such radio systems, and motor vehicles equipped with such radio systems. By way of example, an automotive radio system may contain both an AM/FM tuner module (RXM) with AM/FM front end module (FEM) and a DAB RXM with DAB FEM having individual antennas for receiving AM, FM, and DAB RF signals. Existing vehicle radio systems employ a dedicated RF coax cable to connect the AM/FM antenna and FEM with low-noise amplifier (LNA) to the AM/FM receiver with LNA, a separate dedicated RF coax cable to connect the DAB antenna and FEM with LNA to the DAB receiver and LNA, and discrete accessory cables for powering the front-end and back-end modules. These wiring harnesses—with all the attendant connecting points and electrical hardware—increase system complexity and cost, gross vehicle weight (GVW), and packaging requirements.

Disclosed AM/FM/DAB radio system architectures employ a front-end RF diplexer that combines both FEM antenna line signals for transmission across a single coax cable, and a back-end RF diplexer that separates the signals for conversion of the selected carrier frequencies by their respective receivers. Each diplexer may be integrated into a respective RF/DC triplexer unit that exchanges a direct-current (DC) voltage signal transmitted across the coax connector cable from the back-end radio receiver module (RRM) power supply to power the LNAs in the front-end Tuner Antenna Module (TAM). With this design, some system architectures may employ a single multiband antenna for receiving both AM and FM signals, a single multiband antenna for receiving both FM and DAB signals, or a single multiband antenna for receiving AM, FM and DAB signals. This system design eliminates superfluous coax and DC power cables while reducing the number of RF connectors. In addition to reducing system complexity, vehicle weight, and packaging constraints, disclosed radio system designs may also help to reduce RF signal degradation in order to maintain performance and costumer experience.

Aspects of this disclosure are directed to multiband radio systems with dual RF diplexers and a single front-to-back end connector cable. In an example, a multiband radio system comprises: a tuner antenna module (TAM) unit including a DAB front end module (FEM) with a DAB antenna configured to receive DAB radio frequency (RF) signals, and an AM/FM FEM with an AM antenna configured to receive AM RF signals and an FM antenna configured to receive FM RF signals (note: the AM, FM and/or DAB antennas may be combined into a single or dual-antenna array); a radio receiver module (RRM) unit including a DAB receiver module (RXM) configured to receive and convert the DAB RF signals into DAB audio signals, and an AM/FM RXM configured to receive and convert the AM and FM RF signals into AM/FM audio signals; a single coaxial (coax) cable connecting the TAM unit and the RRM unit to thereby transmit therebetween RF signals; and a front-end (FE) triplexer unit located in the TAM unit and including an FE coax node connected to the single coax cable, an FE AM/FM RF node connected to the AM/FM FEM to receive therefrom the AM and FM RF signals, and an FE DAB RF node connected to the DAB FEM to receive therefrom the DAB RF signals, the FE triplexer unit configured to combine the AM, FM, and DAB RF signals for transmission across the single coax cable to the RRM unit.

The single coax cable may be further configured to transmit direct-current (DC) power from the RRM unit to the TAM unit, and the FE triplexer unit may further include first and second FE DC output nodes electrically connected to the AM/FM FEM and the DAB FEM, respectively, to transmit thereto the DC power, the FE coax node electrically connecting the first and second FE DC output nodes to the single coax cable.

The FE triplexer unit may further include a split-voltage line (SVL) circuit interposed between and electrically connecting the FE coax node to the first and second FE DC output nodes, the SVL circuit being configured to split and, if desired, step down the DC power from the single coax cable into first and second DC voltages.

The SVL circuit may include a main SVL line electrically connected in series with first and second SVL branch lines and the FE coax node, an electromagnetic interference (EMI) filter on the main SVL line, and a DC-DC buck converter and/or a low dropout (LDO) regulator on the second SVL branch line.

The FE triplexer unit may further include a Bias-Tee circuit interposed between and electrically connecting the FE coax node to the SVL circuit, the FE AM/FM RF node, and the FE DAB RF node, the Bias-Tee circuit configured to split the DC power from the RF signals transmitted across the single coax cable.

The multiband radio system may further comprise a back-end (BE) triplexer unit located in the RRM unit and including a BE coax node connected to the single coax cable, a BE AM/FM RF node connected to the AM/FM RXM to transmit thereto the AM and FM RF signals, and a BE DAB RF node connected to the DAB RXM to transmit thereto the DAB RF signals, the BE triplexer unit configured to separate the AM, FM, and DAB RF signals transmitted across the single coax cable from the TAM unit to the RRM unit.

The single coax cable may be further configured to transmit direct-current (DC) power from the RRM unit to the TAM unit, and the BE triplexer unit may further include a BE DC input node configured to electrically connect to a power source to receive therefrom the DC power, the BE coax node electrically connecting the BE DC input node to the single coax cable.

The BE triplexer unit may further include a Bias-Tee circuit interposed between and electrically connecting the BE coax node to the BE DC input node, the BE AM/FM RF node, and the BE DAB RF node, the Bias-Tee circuit configured to combine the DC power with the RF signals transmitted across the single coax cable.

The FE triplexer unit may further include an FE elliptical RF diplexer with an FE AM/FM filter circuit connected to the AM/FM FEM, an FE DAB filter circuit connected to the DAB FEM, and an FE matching filter circuit connecting the FE coax node to the FE AM/FM filter circuit and the DAB AM/FM filter circuit.

The FE matching filter circuit may include a first inductor electrically connected in series with a first capacitor, the FE coax node, and ground.

The FE AM/FM filter circuit may include second, third and fourth inductors electrically connected in series with the FE coax node and the FE AM/FM RF node, and second, third and fourth capacitors electrically interleaved on respective branch lines with the second, third and fourth inductors and the FE AM/FM RF node.

The FE DAB filter circuit may include fifth, sixth and seventh capacitors electrically connected in series with the FE coax node and the FE DAB RF node, and fifth, sixth and seventh inductors electrically interleaved on respective branch lines with the fifth, sixth and seventh capacitors and the FE DAB RF node.

The FE DAB filter circuit may further include eighth and ninth capacitors electrically connected in parallel with each other and in series with the fifth inductor and the ground, and tenth and eleventh capacitors electrically connected in parallel with each other and in series with the sixth inductor and the ground.

The different filters within each RF diplexer and Bias-Tee circuit may take on an assortment of different form factors, including large-lumped components with High-Q values for low frequencies, such as “0805” packages of inductors/capacitors, “0603” packages of inductors/capacitors, and/or “0402” packages of inductors/capacitors.

Additional aspects of this disclosure are directed to motor vehicles equipped with multiband radio systems containing dual RF diplexers and a single front-to-back end connector cable. As used herein, the terms “vehicle” and “motor vehicle” may be used interchangeably and synonymously to include any relevant vehicle platform, such as passenger vehicles, commercial vehicles, industrial vehicles, off-road and all-terrain vehicles, tracked vehicles, farm equipment, motorcycles, watercraft, aircraft, spacecraft, etc. In an example, a motor vehicle comprises: a vehicle body including a passenger cabin; a plurality of road wheels attached to the vehicle body; a prime mover attached to the vehicle body and configured to drive one or more of the road wheels to thereby propel the motor vehicle; and an amplitude-modulation (AM), frequency-modulation (FM), and digital-audio-broadcasting (DAB) multiband radio system attached to the vehicle body.

Continuing with the discussion of the foregoing example, the motor vehicle's multiband radio system includes: a tuner antenna module (TAM) unit mounted on the vehicle body and containing a DAB front end module (FEM) with a DAB antenna configured to receive DAB radio frequency (RF) signals in a DAB RF range, and an AM/FM FEM with an AM antenna configured to receive AM RF signals in an AM RF range and an FM antenna configured to receive FM RF signals in an FM RF range; a radio receiver module (RRM) unit located in the passenger cabin and containing a DAB receiver module (RXM) configured to receive and convert the DAB RF signals into DAB audio signals, and an AM/FM RXM configured to receive and convert the AM and FM RF signals into AM/FM audio signals; single coaxial (coax) cable connecting the TAM unit and the RRM unit to thereby transmit therebetween RF signals and direct-current (DC) power; a front-end (FE) triplexer unit located in the TAM unit and containing an FE coax node connected to the single coax cable, first and second FE DC output nodes connected to the AM/FM FEM and the DAB FEM, respectively, to transmit thereto the DC power, an FE AM/FM RF node connected to the AM/FM FEM to receive therefrom the AM and FM RF signals, and an FE DAB RF node connected to the DAB FEM to receive therefrom the DAB RF signals, the FE triplexer unit configured to combine the AM, FM, and DAB RF signals for transmission across the single coax cable to the RRM unit; and a back-end (BE) triplexer unit located in the RRM unit and containing a BE coax node connected to the single coax cable, a BE DC input node connected to a power source to receive therefrom the DC power, a BE AM/FM RF node connected to the AM/FM RXM to transmit thereto the AM and FM RF signals, and a BE DAB RF node connected to the DAB RXM to transmit thereto the DAB RF signals, the BE triplexer unit configured to separate the AM, FM, and DAB RF signals and transmit the combined signals across the single coax cable to the RRM unit.

Aspects of this disclosure are directed to methods for making and methods for using any of the herein described multiband radio systems and/or motor vehicles. In an example, a method is presented for manufacturing an AM/FM/DAB multiband radio system. This representative method includes, in any order and in any combination with any of the above and below disclosed options and features: assembling a TAM unit including a DAB FEM with a DAB antenna configured to receive DAB RF signals, and an AM/FM FEM with an AM antenna configured to receive AM RF signals and an FM antenna configured to receive FM RF signals; assembling an RRM unit with a DAB RXM configured to receive and convert the DAB RF signals into DAB audio signals, and an AM/FM RXM configured to receive and convert the AM and FM RF signals into AM/FM audio signals; connecting the TAM unit and the RRM unit with only a single coax cable to thereby transmit RF signals between the TAM and RRM units; and locating a FE triplexer unit in the TAM unit, the FE triplexer unit including an FE coax node, an FE AM/FM RF node, and an FE DAB RF node, the FE triplexer unit configured to combine and transmit the AM, FM, and DAB RF signals across the single coax cable; connecting the FE coax node to the single coax cable; connecting the FE AM/FM RF node to the AM/FM FEM to receive therefrom the AM and FM RF signals; and connecting the FE DAB RF node to the DAB FEM to receive therefrom the DAB RF signals.

The single coax cable may be further configured to transmit direct-current (DC) power from the RRM unit to the TAM unit, and the FE triplexer unit may further include first and second FE DC output nodes. The method may further comprise electrically connecting the first and second FE DC output nodes to the AM/FM FEM and the DAB FEM, respectively, to transmit thereto the DC power, and electrically connecting the FE coax node to the first and second FE DC output nodes.

The FE triplexer unit may further include a split-voltage line (SVL) circuit interposed between and electrically connecting the FE coax node to the first and second FE DC output nodes, the SVL circuit being configured to split and, optionally, step down the DC power from the single coax cable into first and second DC voltages.

The FE triplexer unit may further include a Bias-Tee circuit interposed between and electrically connecting the FE coax node to the SVL circuit, the FE AM/FM RF node, and the FE DAB RF node, the Bias-Tee circuit configured to split the DC power from the RF signals transmitted across the single coax cable.

The method may further comprise: locating a back-end (BE) triplexer unit in the RRM unit, the BE triplexer unit including a BE coax node, a BE AM/FM RF node, and a BE DAB RF node, the BE triplexer unit configured to separate the AM, FM, and DAB RF signals transmitted across the single coax cable from the TAM unit to the RRM unit; connecting the BE coax node to the single coax cable; connecting the BE AM/FM RF node to the AM/FM RXM to transmit thereto the AM and FM RF signals; and connecting the BE DAB RF node to the DAB RXM to transmit thereto the DAB RF signals.

The FE triplexer unit may further include an FE elliptical RF diplexer with an FE AM/FM filter circuit connected to the AM/FM FEM, an FE DAB filter circuit connected to the DAB FEM, and an FE matching filter circuit connecting the FE coax node to the FE AM/FM filter circuit and the DAB AM/FM filter circuit.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with a network of in-vehicle controllers, sensors, communication devices, and a centerstack telematics unit with a multiband radio triplexer system in accord with aspects of the present disclosure.

FIG. 2 is a diagrammatic illustration of a representative AM/FM/DAB radio system with dual RF/DC triplexers and a single front-to-back end coax connector cable in accord with aspects of the present disclosure.

FIG. 3 is a schematic illustration of a representative AM/FM/DAB RF diplexer unit that may be incorporated into the front-end and back-end RF/DC triplexers of FIG. 2 in accord with aspects of the present disclosure.

FIG. 4 is a schematic illustration of a representative Bias-Tee circuit for combining or segregating RF and DC signals in the front-end and back-end RF/DC triplexers of FIG. 2 in accord with aspects of the present disclosure.

FIG. 5 is a schematic illustration of a representative Split-Line Voltage circuit for splitting and stepping down a voltage level of a DC input signal in the front-end RF/DC triplexer of FIG. 2 in accord with aspects of the present disclosure.

FIG. 6 is a schematic illustration of another representative Split-Line Voltage circuit for splitting and stepping down a voltage level of a DC input signal in the front-end RF/DC triplexer of FIG. 2 in accord with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, node, vertical, horizontal, upward, downward, front, back, left, right, etc., may be with respect to a motor vehicle, such as a forward driving direction of a motor vehicle when the vehicle is operatively oriented on a horizontal driving surface.

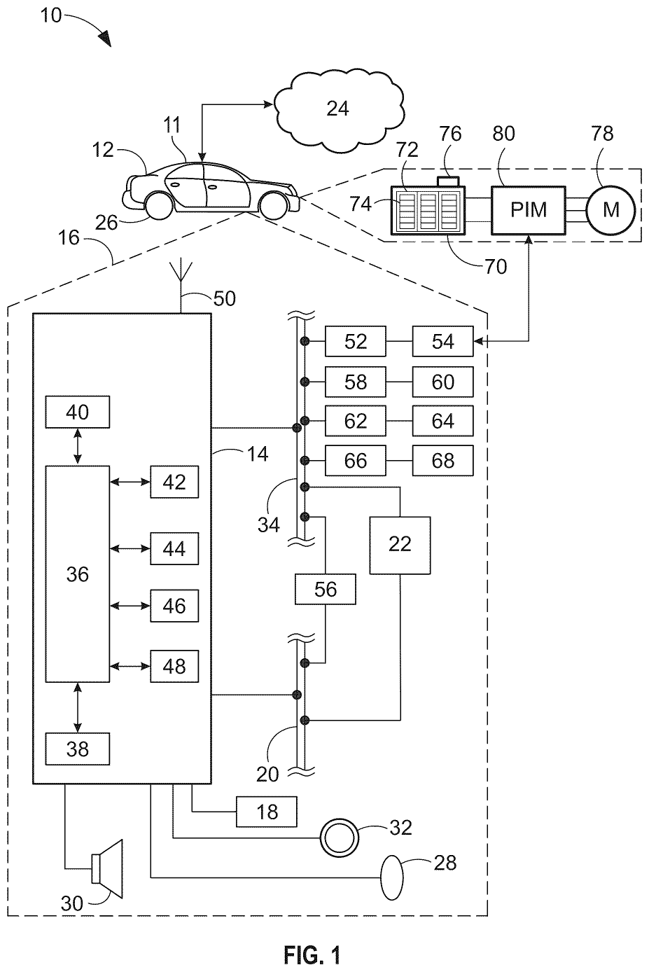

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which novel aspects of this disclosure may be practiced. In the same vein, incorporation of the present concepts into the specific multiband radio system architecture presented in the drawings should also be appreciated as a non-limiting implementation of disclosed features. As such, it will be understood that novel features of this disclosure may be incorporated into other radio system architectures, may be utilized for any logically relevant type of motor vehicle, and may be employed for vehicular and non-vehicular applications alike. Moreover, only select components of the motor vehicle and the multiband radio system are shown and described in detail herein. Nevertheless, the vehicles and radio systems discussed below may include numerous additional and alternative features, and other available peripheral hardware, for carrying out the various methods and functions of this disclosure.

The representative vehicle 10 of FIG. 1 is originally equipped with a vehicle telecommunications and informatics (“telematics”) unit 14 that wirelessly communicates, e.g., via cellular network, satellite service, wireless-enabled modem, etc., with a remotely located cloud computing host service 24 (e.g., ONSTAR®). Some of the other vehicle hardware components 16 shown generally in FIG. 1 include, as non-limiting examples, an electronic video display device 18, a microphone 28, audio speaker(s) 30, and assorted user input controls 32 (e.g., buttons, knobs, switches, touchpads, touchscreens, etc.). These hardware components 16 function, in part, as a human/machine interface (HMI) that enables a user to communicate with the telematics unit 14 and other components resident to and remote from the vehicle 10. Microphone 28, for instance, provides occupants with a means to input verbal commands; the vehicle 10 may be equipped with an embedded voice-processing unit with audio filtering, editing, and analysis modules. Conversely, the speaker 30 provides audible output to a vehicle occupant and may be either a stand-alone speaker dedicated of the telematics unit 14 or may be part of an in-cabin audio system 22. The audio system 22 is connected to a network connection interface 34 and an audio bus 20 to receive analog and digital information, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating friction and regenerative brake systems, controlling vehicle steering, and other automated functions. For instance, telematics unit 14 may exchange signals with a Powertrain Control Module (PCM) 52, an Advanced Driver Assistance System (ADAS) module 54, a Brake System Control Module (BSCM) 56, a Body Control Module (BCM) 58, a Sensor System Interface Module (SSIM) 60, and assorted other vehicle ECUs, such as a Transmission Control Module (TCM), a Sensing and Diagnostics Module (SDM), a Motor Control Module (MCM), etc.

With continuing reference to FIG. 1, telematics unit 14 is an onboard computing device that provides a mixture of services, both individually and through its communication with other networked devices. This telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, solid-state drive (SSD) memory, hard-disk drive (HDD) memory, phase-change memory, flash memory, semiconductor memory (e.g., various types of RAM or ROM), etc.

Long-range communication (LRC) capabilities with remote, off-board devices may be provided via one or more or all of a cellular chipset/component, a navigation and location chipset/component (e.g., global positioning system (GPS) transceiver), a wireless modem, or a mobile hotspot, all of which are collectively represented at 44. Close-range wireless connectivity may be provided via a short-range communication (SRC) device 46 (e.g., a BLUETOOTH® unit or near field communications (NFC) transceiver), a dedicated short-range communications (DSRC) component 48, and/or a dual RF antenna 50. The communications devices described above may provision data exchanges as part of a periodic broadcast in a vehicle-to-vehicle (V2V) communication system or a vehicle-to-everything (V2X) communication system, e.g., Vehicle-to-Infrastructure (V2I), Vehicle-to-Pedestrian (V2P), Vehicle-to-Device (V2D), Vehicle-to-Cloud (V2C), etc.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, for executing a controller-automated (AV/ADAS) driving operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automated vehicle operation.

To propel the automobile 10, a vehicle powertrain is operable to generate and deliver tractive torque to one or more of the vehicle's drive wheels 26. The powertrain is represented in FIG. 1 by an electric traction motor (M) 78 that is operatively connected to a rechargeable energy storage system (RESS), which may be in the nature of a chassis-mounted traction battery pack 70. The traction battery pack 70 is generally composed of one or more battery modules 72 each containing a cluster of battery cells 74, such as lithium-class, zinc-class, nickel-class, or organosilicon-class cells of the pouch, prismatic, or cylindrical type. One or more prime movers, such as traction motor/generator (M) units 78, draw electrical power from and, optionally, deliver electrical power to the battery pack 70. A power inverter module (PIM) 80 electrically connects the battery pack 70 to the motor(s) 78 and modulates the transfer of electrical current therebetween. The battery pack 70 may include an integrated electronics package, such as a wireless-enabled cell monitoring unit (CMU) 76, that enables on-module management, cell sensing, etc.

Many commercially available automotive communication systems include a multiband radio system that supports numerous radio frequency bands, including AM broadcast radio in the 540-1700 kilohertz (kHz) range, FM broadcast radio in the 88-108 megahertz (MHz) range, and wide-band DAB radio in the 174-240 MHz (Band III) or 1.45-1.49 gigahertz (GHz) (L Band) range. These multiband radio systems may employ two distinct RF coax cable lines in conjunction with a separate phantom DC voltage line to wire the in-cabin AM/FM and DAB tuner modules with their respective roof-mounted antenna modules. These radio wiring harnesses, including all of their attendant connecting points and compatible electrical hardware, increase system complexity and costs, gross vehicle weight, and packaging requirements.

Discussed below are multiband AM/FM/DAB radio systems with dual RF/DC triplexers wired together by a solitary front-to-back end coax cable that operatively connects the front-end Tuner Antenna Module (TAM) with the back-end Radio Receiver Module (RRM). Each triplexer unit may contain an elliptical filter-type RF diplexer with low-pass, high-pass, and matching network filters that cooperatively combine (on the front end) or separate (on the back end) AM/FM RF signals with/from DAB RF signals transmitted across the coax connector cable. A Bias-Tee circuit may be placed at the exit (front end) or entrance (back end) of each triplexer to separate (front end) or combine (back end) a DC voltage signal transmitted by the RRM across the single coax to the TAM. This DC signal may be used to provide appropriate voltage to each radio FEM Low Noise Amplifier. Using an elliptical filter-type diplexer may help to eliminate signal reflection and provide exceptional signal isolation in a multiband radio system with a very small frequency separation between the AM/FM frequencies and DAB frequencies. It may be desirable that all of the filters in the RF diplexer use high-Q large 0805 or 0603 or 0402 inductor/capacitor (LC) components to help maintain low loss in low frequencies.

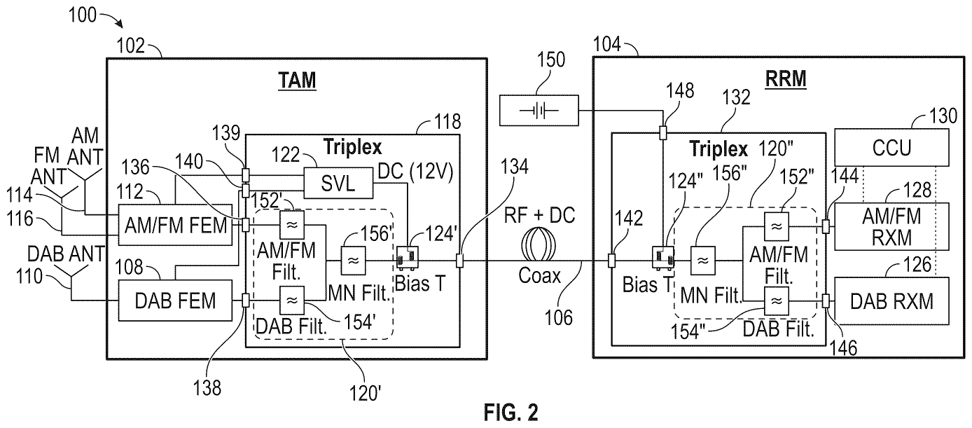

FIG. 2 presents an example of multiband radio system 100 with dual RF/DC triplexers 118 and 132 and a single front-to-back end connector cable 106 for providing AM/FM analog radio services and DAB digital radio services. The multiband AM/FM/DAB radio system 100 is depicted as a tripartite architecture that may be typified by a front-end tuner antenna module unit 102, a radio receiver module unit 104, and a single coaxial cable 106 that is interposed between and connects the TAM and RRM units 102, 104 to transmit therebetween both DC voltage signals and RF antenna line signals. The front-end TAM unit 102 may be mounted onto an external surface of a host vehicle (e.g., roof panel of vehicle body 12 of FIG. 1), whereas the RRM unit 104 may be packaged inside the host vehicle (e.g., integrated into telematics unit 14 inside vehicle passenger cabin 11) and the coaxial cable 106 may be routed from behind the dash panel up through a front screen (A) pillar, and passed through a feed hole in the roof panel to an antenna housing. Although not shown, it should be appreciated that the radio system 100 of FIG. 2 may include additional acoustic hardware, such as multi-channel amplifiers, a ground block, a fuse box, and a set of high, mid, and low-range speaker components. Conversely, the AM/FM/DAB radio system 100 may be characterized by the absence of more than one cable that connects the in-cabin radio tuner with the body-mounted antenna modules.

Front-end TAM unit 102 contains three primary components: a DAB front end module 108 with a DAB antenna 110, an AM/FM front end module 112 with an AM antenna 114 and an FM antenna 116, and a front-end (FE) triplexer unit 118 with integral FE RF diplexer 120′, split-voltage line (SVL) circuit 122, and Bias-Tee circuit 124′. During system use, the DAB antenna 110 may receive DAB radio frequency signals in a DAB RF range, the AM antenna 114 may receive AM RF signals in an AM RF range, and the FM antenna 116 may receive FM RF signals in an FM RF range, with the AM, FM, and DAB RD ranges being mutually exclusive as described above. Each FEM 108, 112 may contain a respective bandpass filter (BPF) for receiving electromagnetic waves from the antenna and removing image frequencies and out-of-band signals, a low-noise amplifier (LNA) for amplifying weak antenna signals without adding noise, and a variable-gain amplifier (VGA) or local oscillator and mixer for signal preconditioning. In at least some applications, the entire front-end TAM unit 102 is packaged inside a rigid and protective antenna housing that is mounted onto the vehicle roof, trunk lid, liftgate, etc.

Back-end RRM unit 104 may contain four primary components: a DAB receiver module 126, an AM/FM receiver module 128, a radio Central Computing Unit (CCU) 130, and a back-end (BE) triplexer unit 132 with integral BE RF diplexer 120″ and Bias-Tee circuit 124″. During system use, the DAB RXM 126 receives preprocessed radio signals from the DAB FEM 108 and converts the received DAB RF signals into DAB audio signals, whereas the AM/FM RXM 128 receives preprocessed radio signals from the AM/FM FEM 112 and converts the AM and FM RF signals into AM/FM audio signals. Each RXM 126, 128 may contain a frequency amplifier for increasing the signal strength of a selected signal, and a stage detector to recover data from the RF signal and produce sound data initially impressed on the carrier wave. The RRM unit 104 may be integrated into an in-cabin stereo head unit that provides occupants with an HMI for operating the radio system 100, including a tuner for selecting a specific signal of a desired radio station, volume controls for selecting a desired volume, and other available features.

With continuing reference to FIG. 2, the front-end triplexer unit 118 may generally function to: (1) combine FM, AM and DAB radio lines output from FEMs 108, 112 into a unified RF line that can be transmitted across the single coaxial cable 106; and (2) separate from the unified RF line a DC voltage signal transmitted across the single coaxial cable 106 from the BE triplexer unit 132. In accord with the illustrated example, the FE triplexer unit 118 has an FE coax node 134 that is connected to the coax cable 106, an FE AM/FM RF node 136 that is connected to the AM/FM FEM 112 to receive therefrom AM and FM RF signals, and an FE DAB RF node 138 that is connected to the DAB FEM 108 to receive therefrom DAB RF signals. Through the FE RF diplexer 120′, the FE triplexer unit 118 may combine AM, FM, and DAB line signals for transmission across the coax cable 106 to the RRM unit 104. FE triplexer unit 118 may also include a pair of (first and second) FE DC output nodes 139 and 140 that each electrically connects to a respective one of the FEMs 108, 112 to transmit thereto the DC power from the coax cable 106. To that end, the two FE DC output nodes 139, 140 electrically connect through the SVL circuit 122, Bias-Tee circuit 124′ and FE coax node 134 to the single coax cable 106.

Presented as a partially mirrored counterpart to the FE triplexer unit 118, the BE triplexer unit 132 may generally function to: (1) separate a unified RF line transmitted across the single coax cable 106 from the TAM 102 into distinct FM/AM and DAB radio lines; and (2) combine a DC voltage signal with the unified RF line for transmission across the coax cable 106 to the FE triplexer unit 118. As shown, BE triplexer unit 132 has a BE coax node 142 that is connected to the single coax cable 106, a BE AM/FM RF node 144 that is connected to the AM/FM RXM 128 to transmit thereto AM/FM RF signals, and a BE DAB RF node 146 that is connected to the DAB RXM 126 to transmit thereto DAB RF signals. Through the BE RF diplexer 120″, the BE triplexer unit 132 may separate the AM, FM, and DAB RF signals transmitted across the single coax cable 106 from the TAM unit 102. BE triplexer unit 132 may also include a BE DC input node 148 that electrically connects to a low-voltage power source 150 (e.g., 12V, 8.5V or 5V battery) to receive therefrom a DC power signal. To that end, the DC input node 148 may electrically connect through the Bias-Tee circuit 124′ and BE coax node 142 to the single coax cable 106. While shown outside of the RRM 104, the power source 150 may be routed through the CCU 130 or other suitable electrical connection node of the RRM 104 to the Bias-Tee 124′.

As noted above, a split-voltage line circuit 122 may be interposed between and may electrically connect the FE coax node 134 and Bias-Tee circuit 124′ to the two FE DC output nodes 139, 140 and FEMs 108, 112. This SVL circuit 122 may be designed to step down and split the DC power received from the single coax cable (e.g., Vᵢₙ=12V or 8V DC signal) into distinct (first and second) DC voltages (e.g., V₁=12V or 8V and V₂=3V or 5V). By way of non-limiting example, a representative SVL circuit 422 is presented in FIG. 5 with a main SVL line 460 that is electrically connected in series with the FE coax node 134 and a pair of (first and second) SVL branch lines 462 and 464, each of which connects to a respective DC output node 139, 140. In this example, an electromagnetic interference (EMI) filter 466 is located on the main SVL line 460 and a low dropout (LDO) regulator 468 is located on the second SVL branch line 464 upstream from the DC output node 139 and AM/FM FEM 112. In another example, a representative SVL circuit 522 is presented in FIG. 6 with an EMI filter 466 located on the main SVL line 460, and a DC-DC buck (BUC) converter 570, second EMI filter 566, and LDO regulator 468 in series with one another on the second SVL branch line 464 upstream from the FE DC output node 139 and AM/FM FEM 112. Each SVL branch line 462 and 464 may transmit a respective output voltage V₁, V₂ to one of the FEMs 108, 112 to feed the internal low-noise amplifier (LNA) components inside the modules.

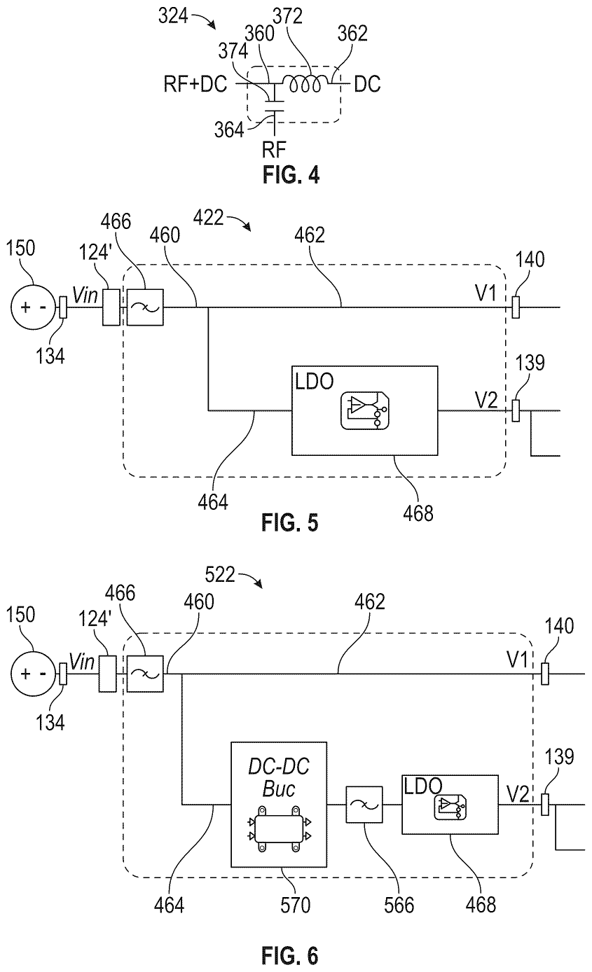

With reference again to FIG. 2, an FE Bias-Tee circuit 124′ may be integrated into the FE triplexer 118, interposed between and electrically connecting the FE coax node 134 to the SVL circuit 122 and, thus, the two DC output nodes 139, 140. Likewise, a BE Bias-Tee circuit 124″ may be integrated into the BE RF diplexer 120″, interposed between and electrically connecting the BE coax node 142 to the triplexer's DC input node 148 and, thus, the voltage power source 150. As previously noted, each Bias-Tee circuit 124′, 124″ either combines (back end) or separates (front end) a DC voltage signal with/from a unified AM/FM/DAB signal being transmitted across the single coax cable 106. By way of non-limiting example, a representative Bias-Tee (BT) circuit 324 is presented in FIG. 4 with a main BT line 360 that is electrically connected in series with a coax node 134, 142 and a pair of (first and second) BT branch lines 362 and 364. A BT resistor 372 is located on the first BT branch line 362 and electrically connected in series with the coax node 134, 142 and either the SVL circuit 122 (front end) or the DC input node 148 (back end). Located on the second BT branch line 364 is a BT capacitor 374 that is electrically connected in series with the coax node 134, 142 and either the FE RF diplexer 120′ (in the TAM 102) or the BE RF diplexer 120″ (in the RRM 104). For simplicity of design and manufacture, it may be desirable that the arrangement and constituent parts of the two Bias-Tee circuits 124′,124″ of FIG. 2 be substantially identical to each other.

Each of the RF/DC triplexer units 118, 132 may contain a respective elliptical filter-type RF diplexer 120′, 120″ with low-pass, high-pass, and matching network filters that cooperatively combine (on the front end) or separate (on the back end) AM/FM/RF signals with/from DAB RF signals transmitted across the single coax cable 106. Inside the FE triplexer 118, the FE RF diplexer 120′ contains an FE AM/FM filter circuit 152′ that is connected to the AM/FM FEM 112 via RF node 136, an FE DAB filter circuit 154′ that is connected to the DAB FEM 108 via RF node 138, and an FE matching network (MN) filter circuit 156′ that is interposed between and electrically connects the FE coax node 134 to the FE AM/FM filter circuit 152′ and FE DAB filter circuit 154′. For the BE triplexer 132, the BE RF diplexer 120′ contains a BE AM/FM filter circuit 152″ that is connected to the AM/FM RXM 128 via RF node 144, a BE DAB filter circuit 154″ that is connected to the DAB RXM 126 via RF node 146, and a BE MN filter circuit 156″ that is interposed between and electrically connects the BE coax node 142 to the BE AM/FM filter circuit 152″ and BE DAB filter circuit 154″. In accord with the illustrated example, the coax cable 106 acts as the lone umbilical connector between the two RF diplexers 120′, 120″.

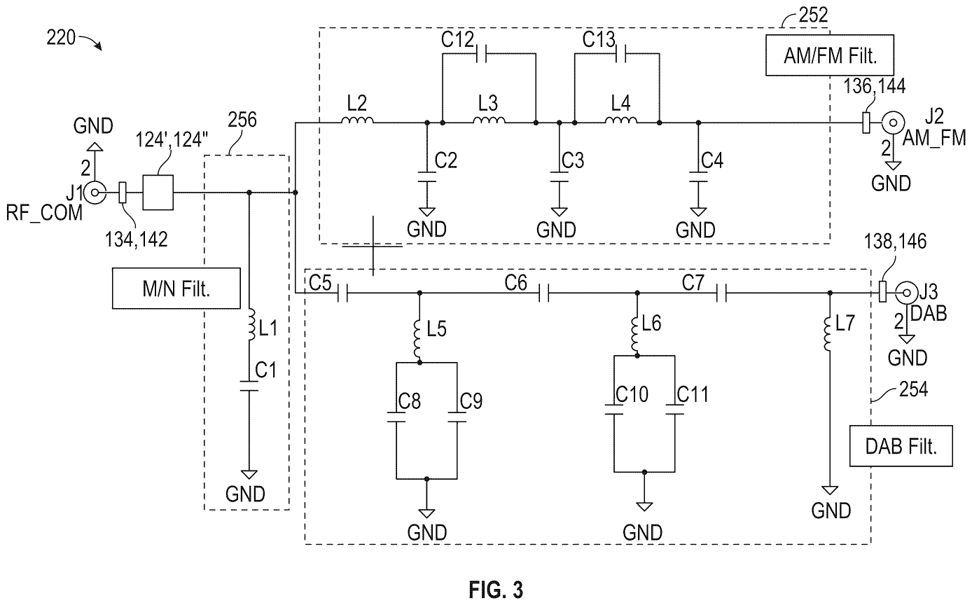

The front-end and back-end RF diplexers 120′, 120″ of FIG. 2 may be mirrored counterparts to each other such that they provide opposite functionalities, i.e., with the former merging FM, AM and DAB radio lines into a unified RF line and the latter dividing the unified RF line into separate FM, AM and DAB radio lines. For simplicity of design and manufacture, it may be desirable that the arrangement and constituent parts of the two diplexers 120′, 120″ be substantially identical to each other. Presented in FIG. 3, for example, is a representative RF diplexer unit 220 that may be incorporated into the RF/DC triplexers 118, 132 of FIG. 2. Like diplexers 120′, 120″, the RF diplexer unit 220 contains three interconnected filters: (1) an MN filter circuit 256 that is electrically connected in series with the single coax cable 106 via coax node 134, 142; (2) an AM/FM filter circuit 252 that is electrically connected in series with the Bias-Tee circuit 124′ 124″ and the AM/FM FEM 112 or RXM 128 via nodes 136, 144; and (3) a DAB filter circuit 254 that is electrically connected in series with the Bias-Tee circuit 124′ 124″ and the DAB FEM 108 or RXM 126 via nodes 138, 146. The MN filter circuit 256 of FIG. 3 may be composed of a first inductor L1 that is electrically connected in series with a first capacitor C1. The MN filter's inductor L1 and capacitor C1 are interposed between and electrically connected in series with a ground block GND and the FE/BE Bias-Tee circuit 124′ 124″.

With continuing reference to FIG. 3, the AM/FM filter circuit 252 contains second, third and fourth inductors L2, L3, and L4, respectively, that are electrically connected in series with one another as well as with the coax node 134, 142 and the AM/FM RF node 136, 144. Second, third and fourth capacitors C2, C3, and C4, respectively, are located on respective branch lines that are electrically interleaved on with the second, third and fourth inductors L2, L3, L4 and the AM/FM RF node 136, 144 (i.e., inductor-capacitor-inductor-capacitor-inductor-capacitor-node). Each of these three capacitors C2, C3, and C4 has a direct serial connection to the ground block GND. In addition, a twelfth capacitor C12 is electrically connected in parallel with the third inductor L3, and a thirteenth capacitor C13 is electrically connected in parallel with the fourth inductor L4.

The DAB filter circuit 254 of FIG. 2 contains fifth, sixth and seventh capacitors C5, C6, and C7, respectively, that are electrically connected in series with one another as well as with the coax node 134, 142 and the DAB RF node 138, 146. Fifth, sixth and seventh inductors L5, L6, and L7, respectively, are located on respective branch lines that are electrically interleaved with the fifth, sixth and seventh capacitors C5, C6, C7 and the DAB RF node 138, 146 (i.e., capacitor-inductor-capacitor-inductor-capacitor-inductor-node). The seventh inductor L7 has a direct serial connection to the ground block GND. Conversely, eighth and ninth capacitors C8 and C9, respectively, are electrically connected in parallel with each other and in series with the fifth inductor C5 and the ground block GND such that the two capacitors C8 and C9 are electrically interposed between the inductor C5 and ground GND. Tenth and eleventh capacitors C10 and C11, respectively, are electrically connected in parallel with each other and in series with the sixth inductor L6 and the ground block GND such that the two capacitors C10 and C11 are electrically interposed between the inductor C6 and ground GND.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. An amplitude-modulation (AM), frequency-modulation (FM), and digital-audio-broadcasting (DAB) multiband radio system, the multiband radio system comprising:
a tuner antenna module (TAM) unit including a DAB front end module (FEM) with a DAB antenna configured to receive DAB radio frequency (RF) signals, and an AM/FM FEM with an AM antenna configured to receive AM RF signals and an FM antenna configured to receive FM RF signals;
a radio receiver module (RRM) unit including a DAB receiver module (RXM) configured to receive and convert the DAB RF signals into DAB audio signals, and an AM/FM RXM configured to receive and convert the AM and FM RF signals into AM/FM audio signals;
a single coaxial (coax) cable connecting the TAM unit and the RRM unit to thereby transmit therebetween RF signals; and
a front-end (FE) triplexer unit located in the TAM unit and including an FE coax node connected to the single coax cable, an FE AM/FM RF node connected to the AM/FM FEM to receive therefrom the AM and FM RF signals, and an FE DAB RF node connected to the DAB FEM to receive therefrom the DAB RF signals, the FE triplexer unit configured to combine the AM, FM, and DAB RF signals for transmission across the single coax cable to the RRM unit.

2. The multiband radio system of claim 1, wherein the single coax cable is further configured to transmit direct-current (DC) power from the RRM unit to the TAM unit, and wherein the FE triplexer unit further includes first and second FE DC output nodes electrically connected to the AM/FM FEM and the DAB FEM, respectively, to transmit thereto the DC power, the FE coax node electrically connecting the first and second FE DC output nodes to the single coax cable.

3. The multiband radio system of claim 2, wherein the FE triplexer unit further includes a split-voltage line (SVL) circuit interposed between and electrically connecting the FE coax node to the first and second FE DC output nodes, the SVL circuit being configured to split the DC power from the single coax cable into first and second DC voltages.

4. The multiband radio system of claim 3, wherein the SVL circuit includes a main SVL line electrically connected in series with first and second SVL branch lines and the FE coax node, an electromagnetic interference (EMI) filter on the main SVL line, and a DC-DC buck converter and/or a low dropout (LDO) regulator on the second SVL branch line.

5. The multiband radio system of claim 3, wherein the FE triplexer unit further includes a Bias-Tee circuit interposed between and electrically connecting the FE coax node to the SVL circuit, the FE AM/FM RF node, and the FE DAB RF node, the Bias-Tee circuit configured to split the DC power from the RF signals transmitted across the single coax cable.

6. The multiband radio system of claim 1, further comprising a back-end (BE) triplexer unit located in the RRM unit and including a BE coax node connected to the single coax cable, a BE AM/FM RF node connected to the AM/FM RXM to transmit thereto the AM and FM RF signals, and a BE DAB RF node connected to the DAB RXM to transmit thereto the DAB RF signals, the BE triplexer unit configured to separate the AM, FM, and DAB RF signals transmitted across the single coax cable from the TAM unit to the RRM unit.

7. The multiband radio system of claim 6, wherein the single coax cable is further configured to transmit direct-current (DC) power from the RRM unit to the TAM unit, and wherein the BE triplexer unit further includes a BE DC input node configured to electrically connect to a power source to receive therefrom the DC power, the BE coax node electrically connecting the BE DC input node to the single coax cable.

8. The multiband radio system of claim 7, wherein the BE triplexer unit further includes a Bias-Tee circuit interposed between and electrically connecting the BE coax node to the BE DC input node, the BE AM/FM RF node, and the BE DAB RF node, the Bias-Tee circuit configured to combine the DC power with the RF signals transmitted across the single coax cable.

9. The multiband radio system of claim 1, wherein the FE triplexer unit further includes an FE elliptical RF diplexer with an FE AM/FM filter circuit connected to the AM/FM FEM, an FE DAB filter circuit connected to the DAB FEM, and an FE matching filter circuit connecting the FE coax node to the FE AM/FM filter circuit and the DAB AM/FM filter circuit.

10. The multiband radio system of claim 9, wherein the FE matching filter circuit includes a first inductor electrically connected in series with a first capacitor, the FE coax node, and ground.

11. The multiband radio system of claim 10, wherein the FE AM/FM filter circuit includes second, third and fourth inductors electrically connected in series with the FE coax node and the FE AM/FM RF node, and second, third and fourth capacitors electrically interleaved on respective branch lines with the second, third and fourth inductors and the FE AM/FM RF node.

12. The multiband radio system of claim 11, wherein the FE DAB filter circuit includes fifth, sixth and seventh capacitors electrically connected in series with the FE coax node and the FE DAB RF node, and fifth, sixth and seventh inductors electrically interleaved on respective branch lines with the fifth, sixth and seventh capacitors and the FE DAB RF node.

13. The multiband radio system of claim 12, wherein the FE DAB filter circuit further includes eighth and ninth capacitors electrically connected in parallel with each other and in series with the fifth inductor and the ground, and tenth and eleventh capacitors electrically connected in parallel with each other and in series with the sixth inductor and the ground.

14. A motor vehicle, comprising:
a vehicle body including a passenger cabin;
a plurality of road wheels attached to the vehicle body;
a prime mover attached to the vehicle body and configured to drive one or more of the road wheels to thereby propel the motor vehicle; and
an amplitude-modulation (AM), frequency-modulation (FM), and digital-audio-broadcasting (DAB) multiband radio system, including:
a tuner antenna module (TAM) unit mounted on the vehicle body and containing a DAB front end module (FEM) with a DAB antenna configured to receive DAB radio frequency (RF) signals in a DAB RF range, and an AM/FM FEM with an AM antenna configured to receive AM RF signals in an AM RF range and an FM antenna configured to receive FM RF signals in an FM RF range;
a radio receiver module (RRM) unit located in the passenger cabin and containing a DAB receiver module (RXM) configured to receive and convert the DAB RF signals into DAB audio signals, and an AM/FM RXM configured to receive and convert the AM and FM RF signals into AM/FM audio signals;
a single coaxial (coax) cable connecting the TAM unit and the RRM unit to thereby transmit therebetween RF signals and direct-current (DC) power;
a front-end (FE) triplexer unit located in the TAM unit and containing an FE coax node connected to the single coax cable, first and second FE DC output nodes connected to the AM/FM FEM and the DAB FEM, respectively, to transmit thereto the DC power, an FE AM/FM RF node connected to the AM/FM FEM to receive therefrom the AM and FM RF signals, and an FE DAB RF node connected to the DAB FEM to receive therefrom the DAB RF signals, the FE triplexer unit configured to combine the AM, FM, and DAB RF signals for transmission across the single coax cable to the RRM unit; and
a back-end (BE) triplexer unit located in the RRM unit and containing a BE coax node connected to the single coax cable, a BE DC input node connected to a power source to receive therefrom the DC power, a BE AM/FM RF node connected to the AM/FM RXM to transmit thereto the AM and FM RF signals, and a BE DAB RF node connected to the DAB RXM to transmit thereto the DAB RF signals, the BE triplexer unit configured to separate the AM, FM, and DAB RF signals and transmit the combined signals across the single coax cable to the RRM unit.

15. A method of manufacturing an amplitude-modulation (AM), frequency-modulation (FM), and digital-audio-broadcasting (DAB) multiband radio system, the method comprising:
assembling a tuner antenna module (TAM) unit including a DAB front end module (FEM) with a DAB antenna configured to receive DAB radio frequency (RF) signals, and an AM/FM FEM with an AM antenna configured to receive AM RF signals and an FM antenna configured to receive FM RF signals;
assembling a radio receiver module (RRM) unit with a DAB receiver module (RXM) configured to receive and convert the DAB RF signals into DAB audio signals, and an AM/FM RXM configured to receive and convert the AM and FM RF signals into AM/FM audio signals;
connecting the TAM unit and the RRM unit with only a single coaxial (coax) cable to thereby transmit RF signals between the TAM and RRM units; and
locating a front-end (FE) triplexer unit in the TAM unit, the FE triplexer unit including an FE coax node, an FE AM/FM RF node, and an FE DAB RF node, the FE triplexer unit configured to combine and transmit the AM, FM, and DAB RF signals across the single coax cable;
connecting the FE coax node to the single coax cable;
connecting the FE AM/FM RF node to the AM/FM FEM to receive therefrom the AM and FM RF signals; and
connecting the FE DAB RF node to the DAB FEM to receive therefrom the DAB RF signals.

16. The method of claim 15, wherein the single coax cable is further configured to transmit direct-current (DC) power from the RRM unit to the TAM unit, and wherein the FE triplexer unit further includes first and second FE DC output nodes, the method further comprising:
electrically connecting the first and second FE DC output nodes to the AM/FM FEM and the DAB FEM, respectively, to transmit thereto the DC power; and
electrically connecting the FE coax node to the first and second FE DC output nodes.

17. The method of claim 16, wherein the FE triplexer unit further includes a split-voltage line (SVL) circuit interposed between and electrically connecting the FE coax node to the first and second FE DC output nodes, the SVL circuit being configured to split the DC power from the single coax cable into first and second DC voltages.

18. The method of claim 17, wherein the FE triplexer unit further includes a Bias-Tee circuit interposed between and electrically connecting the FE coax node to the SVL circuit, the FE AM/FM RF node, and the FE DAB RF node, the Bias-Tee circuit configured to split the DC power from the RF signals transmitted across the single coax cable.

19. The method of claim 15, further comprising:
locating a back-end (BE) triplexer unit in the RRM unit, the BE triplexer unit including a BE coax node, a BE AM/FM RF node, and a BE DAB RF node, the BE triplexer unit configured to separate the AM, FM, and DAB RF signals transmitted across the single coax cable from the TAM unit to the RRM unit;
connecting the BE coax node to the single coax cable;
connecting the BE AM/FM RF node to the AM/FM RXM to transmit thereto the AM and FM RF signals; and
connecting the BE DAB RF node to the DAB RXM to transmit thereto the DAB RF signals.

20. The method of claim 15, wherein the FE triplexer unit further includes an FE elliptical RF diplexer with an FE AM/FM filter circuit connected to the AM/FM FEM, an FE DAB filter circuit connected to the DAB FEM, and an FE matching filter circuit connecting the FE coax node to the FE AM/FM filter circuit and the DAB AM/FM filter circuit.
